(19) United States
(12) Patent Application Publication
(10) Pub. No.: US 2002/0087402 A1
(43) Pub. Date: Jul. 4, 2002

(54) User selective advertising

(76) Inventors: Fred J. Zustak, Poway, CA (US); Matthew S. Chang, San Diego, CA (US); Aditya Krishnan, San Diego, CA (US); Andrew M. Proehl, San Francisco, CA (US); David K.L. Yang, San Jose, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/752,632

(22) Filed: Jan. 2, 2001

(51) Int. Cl. G06F 17/60

(52) U.S. Cl. 705/14; 705/26

(57) ABSTRACT

An advertisement method and apparatus. A user is presented with a menu of advertisements and/or advertisement types for selection. Upon selection of the desired advertisement and/or advertisement type, advertisements are downloaded to the user's set-top box storage for merging with entertainment content for presentation to the user.

### FIELD OF THE INVENTION

This invention relates generally to the field of advertising. More particularly, this invention relates to a method of enhancing the effectiveness of advertising during playback of stored entertainment content.

### BACKGROUND OF THE INVENTION

Television advertising spots are typically in the form of commercial segments (“commercials”) in which the entertainment contents such as a television program is periodically interrupted to present commercials to the viewer. As used herein, the term content is intended to embrace television programming including entertainment programming, movies, sporting events, news programs and generally anything that would commonly be referred to as a television program. This traditional technique for providing advertisements in the form of commercials has varying levels of success in reaching the target viewing audience. Although demographic and other tools can be utilized to match up appropriate advertising with programming, often conventional commercials are not effective since the viewer may take the opportunity of a commercial break to, for example, to get a snack or use the restroom.

Recently, certain television broadcasters, cable networks and videotape suppliers have utilized so-called “watermarks” to provide the user with a constant reminder of the source of programming. Such watermarks are logos or insignias that appear, for example, in the bottom right hand corner of a television image and generally allow the image to show through the watermark while providing the viewer with the ability to still clearly see the insignia or logo during most types of video. Another type of advertisement has also become popular recently with the advent of the Internet and the worldwide web. So-called banner ads, which may take the form of a scrolling banner at the top, bottom or other location in the video image (including an open window) provides text or video advertisement.

Unfortunately heretofore, the art of supplying a viewer with an appropriately targeted advertisement has been totally out of the control of the viewer. This is true both in the case of selection of advertisement as well as selection of advertising mechanism. The present invention is intended to address this issue.

### SUMMARY OF THE INVENTION

The present invention relates generally to advertising. Objects, advantages and features of the invention will become apparent to those skilled in the art upon consideration of the following detailed description of the invention.

One embodiment of the present invention relates to an advertisement method and apparatus in which a user is presented with a menu of advertisements and/or advertisement types for selection. Upon selection of the desired advertisement and/or advertisement type, advertisements are downloaded to the user's set-top box storage for merging with entertainment content for presentation to the user.

A method of advertising consistent with an embodiment of the invention includes: presenting a menu of possible advertisements to a user to permit the user to select an advertisement to view; receiving a user selection of an advertisement to view; and merging the advertisement with the stored entertainment content so that both the advertisement and the stored entertainment content are played back or presented to the user.

An electronic storage medium containing instructions which, when executed on a programmed processor carry out a process of advertising consistent with an embodiment of the invention including: presenting a menu possible advertisements to a user to permit the user to select an advertisement to view; receiving a user selection of an advertisement to view; receiving the selected advertisement from an advertising server; and merging the advertisement with the stored entertainment content so that both the advertisement and the stored entertainment content are played back or presented to the user.

A set-top box consistent with one embodiment of the invention includes a programmed processor that presents a user with a menu of advertisements. A user selection of a selected advertisement from the menu of advertisements is received by the user. The selected advertisement is received from a service provider. The content is also received from the service provider. The programmed processor merges the entertainment content with the advertisement for presentation to the user.

A method of advertising consistent with another embodiment of the invention includes: presenting a menu of possible types of advertisements to a user to permit the user to select a type of advertisement to view; receiving a user selection of a type of advertisement to view; receiving an advertisement of the selected advertisement type from an advertising server; and merging the advertisement with the stored entertainment content so that both the advertisement and the stored entertainment content are presented to the user.

An electronic storage medium containing instructions which, when carried out by a programmed processor, implements a method of advertising consistent with the present invention including: presenting a menu of possible types of advertisements to a user to permit the user to select a type of advertisement to view; receiving a user selection of a type of advertisement to view; receiving an advertisement of the selected advertisement type from an advertising server; and merging the advertisement with the stored entertainment content so that both the advertisement and the stored entertainment content are presented to the user.

A set-top box consistent with another embodiment of the invention includes a programmed processor that presents a user with a menu of advertisement types. A receiver that receives a user selection of a selected advertisement type from the menu of advertisements. The selected advertisement is received from a service provider. The entertainment content is also received from the service provider. The programmed processor merges the entertainment content with the advertisement for presentation to the user.

An advertising method consistent with embodiments of the invention includes: presenting a television viewer with a menu of advertisements from which to select an advertisement for viewing; receiving an advertisement selection from the television viewer; and presenting the television viewer with the selected advertisement.

Another advertisement method consistent with embodiments of the invention includes: presenting the television viewer with a menu of advertisement types; receiving an advertisement type selection from the television viewer; and presenting the television viewer with the selected advertisement according to the selected advertisement type.

The above summaries are intended to illustrate exemplary embodiments of the invention, which will be best understood in conjunction with the detailed description to follow and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 depicts a screen image of an advertisement menu consistent with certain embodiments of the invention.

FIG. 4 depicts a screen image of a watermark advertisement consistent with certain embodiments of the invention.

FIG. 5 depicts a screen image of a banner advertisement consistent with certain embodiments of the invention.

FIG. 6 is a flow chart describing one embodiment of the present invention.

FIG. 7 is a flow chart describing another embodiment of the present invention.

FIG. 8 depicts a screen image of another embodiment of an advertisement menu and an advertisement type menu consistent with certain embodiments of the invention.

FIG. 9 is a flow chart describing another embodiment of the present invention.

FIG. 10 is a flow chart describing another embodiment of the present invention.

### DETAILED DESCRIPTION OF THE INVENTION

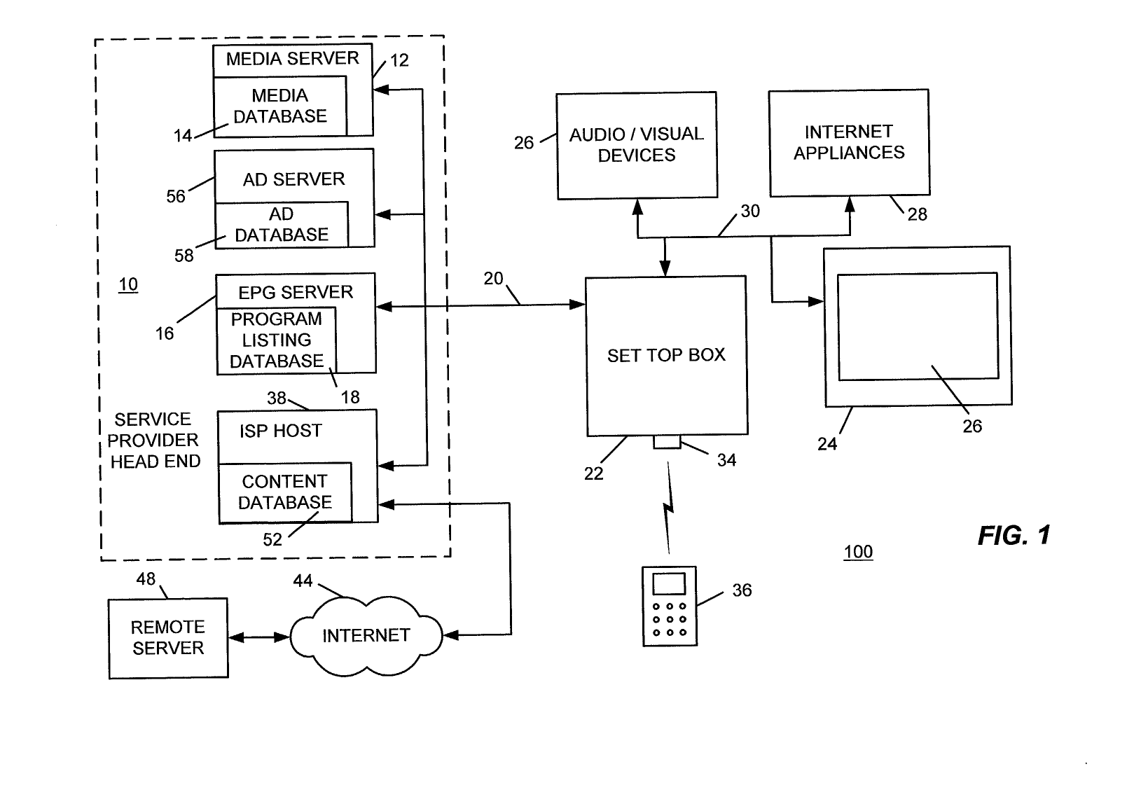

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings. Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet. The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, Nov. 1999.

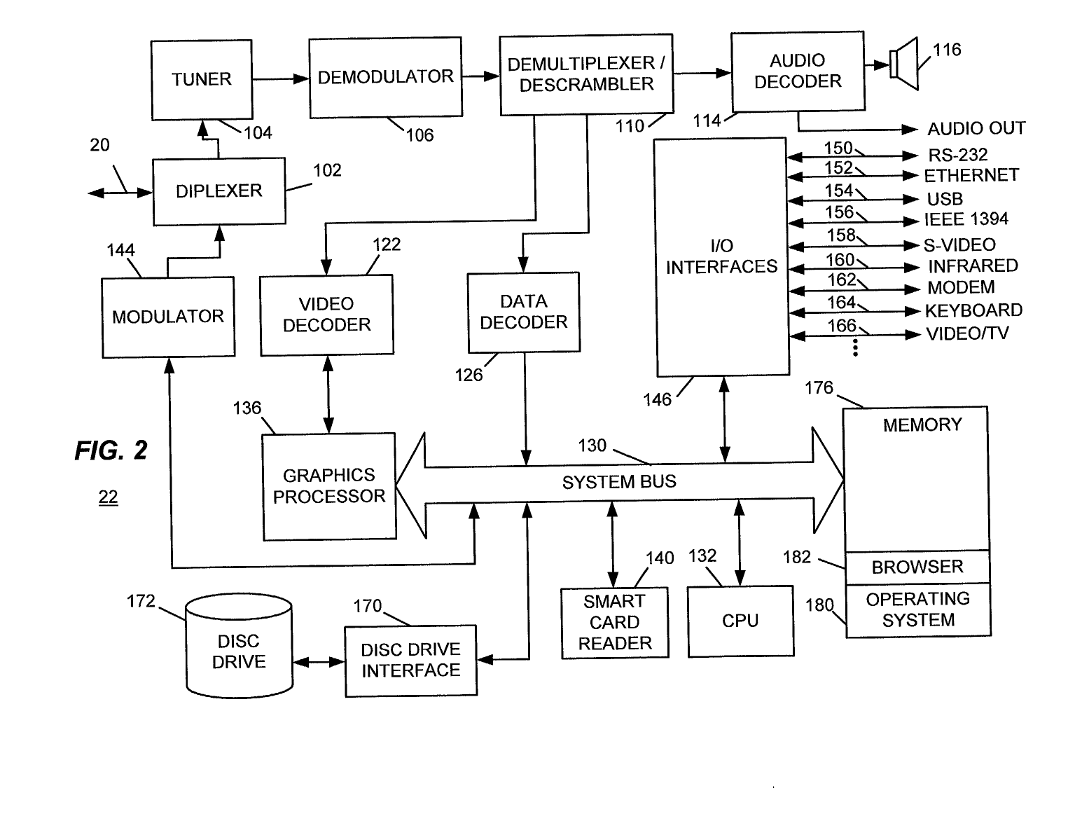

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE T could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

In accordance with embodiments of the invention, the user is given various options regarding the type of advertisement as well as how the advertisement is presented. While the user still has to be presented with advertisements, he or she can exercise a preference for both advertiser and advertisement type. Referring back to FIG. 1, in addition to media server 12, EPG server 16 and ISP host 38, the service provider 10 includes an advertising server 56 that includes a database of advertisements 58 for presentation to the ultimate viewer. Servers 12, 16 and as well as ISP host 38 although shown as independent servers with independent databases may be implemented in any suitable manner including implementation on more or fewer computers than those illustrated. Moreover, these servers generally operate in a coordinated manner to provide the services described herein. The actual hardware configuration at the service provider head end may differ substantially than that shown without departing from the present invention.

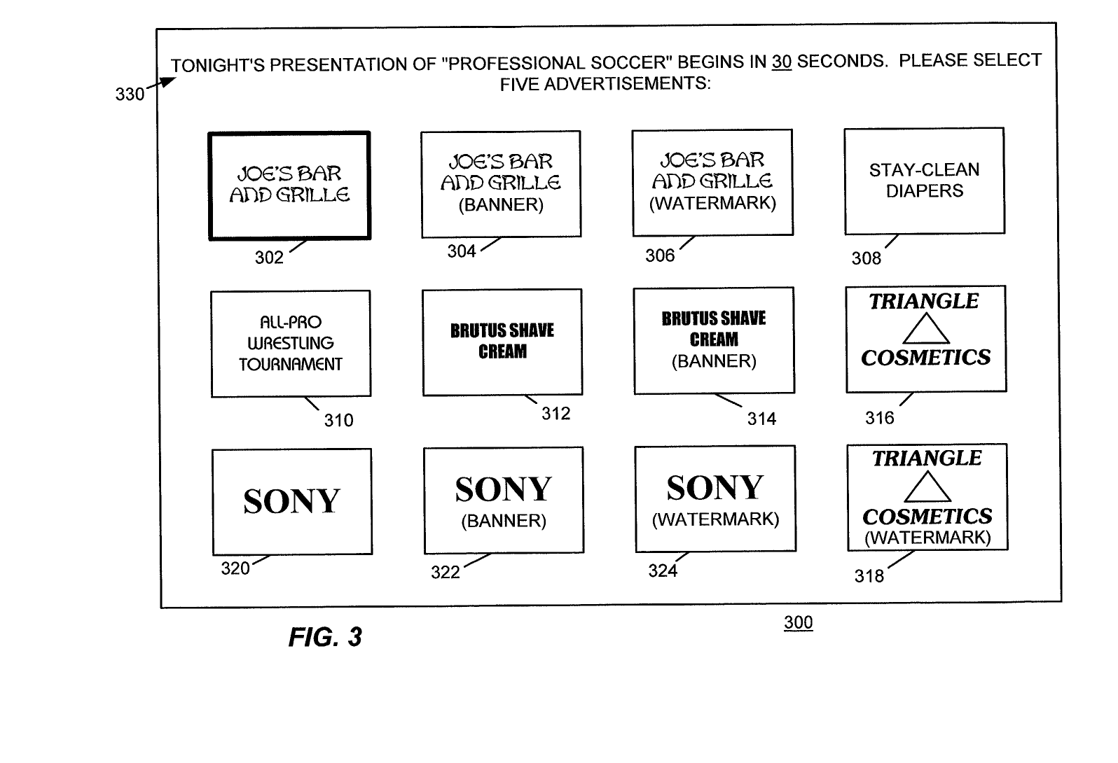

Referring now to FIG. 3, a screen image illustrating one embodiment of the present invention is shown as 300 as it might appear on display 26. In this embodiment, the user is presented with a plurality of possible advertisements shown as 302 through 324 and is instructed by an instruction area 330 to select the particular number of advertisements to be viewed during a presentation of programming that follows. For example, in the example shown as 300, the user is presented with 12 possible advertisements to be presented during a professional soccer event and the user is given 30 seconds in which to select 5 of the advertisements.

As shown, the available advertisements include advertisements for multiple advertisers as well as multiple formats. Menu icons representing advertisements 302, 304 and 306 are, for example from the same advertiser with three different advertisement types (conventional commercial segment, banner or watermark), but other types of advertisements (e.g. panel advertisement that repeatedly pop up as a window on the screen for several seconds) can also be used. Similarly, Advertisement groups 312 and 314; 316 and 318; and 320, 322 and 324 depict advertisements of varying types for the same advertiser. Conventional commercial segment type advertisements are depicted by menu selection icons 302, 308, 310, 312, 316 and 320. Banner type advertisements are represented by menu selection icons 304, 314 and 322. Watermark type advertisements are represented by menu selection icons 306, 314, 318 and 322. Thus, for example, if the user selects 320, a conventional commercial segment will interrupt the presentation periodically. If the user selects menu icon 322, a banner advertisement will appear either during presentation of the programming material or as a substitute for the commercial segment during the time slot normally occupied by such a commercial segment. Finally, if the user selects menu icon 324, a logo will be displayed as a watermark throughout at least a portion of the programming. In this manner, the user can select from among various advertisers and types of advertising to both optimize the presentation of information to the viewer (because the viewer gets to select items that might be of interest) as well as selecting the advertising mechanism. Thus, the user can determine if he wishes to view a full advertisement, or view a less intrusive form of advertisement such as a watermark. The actual level of intrusiveness of any particular type of advertisement depends upon a number of factors including the size of a banner or watermark, etc.

The user, for example, may desire to see a full commercial message for some advertisers and thus accept a 30-second or 1 minute (or more or less) of an interruption in the programming content periodically. If, however, the user prefers to view the content substantially uninterrupted, he may wish to trade off the interruption time for a longer presentation of a banner advertisement or perhaps an even longer display of a watermark type advertisement. It is contemplated, for example, that a 30-second commercial interruption might be traded off for a longer presentation (e.g. perhaps 5 minutes) of banners or an even longer presentation (e.g. 20 minutes) watermark advertisement. In general, it is contemplated that more intrusive advertisements can be shown for shorter times than more intrusive advertisements. In any case, the user has the option to select the preferred advertising mechanism and perhaps more importantly, to not be bothered with advertisements that are of no interest. Moreover, the service provider is given the flexibility of providing varying types of advertisements for varying lengths of time with perhaps differing charges to the advertiser.

The present invention can thus be implemented through use of the programmed processor CPU 132 of set-top box 22 with the user making selections of the appropriate advertisements utilizing remote control 36 to navigate through the menu of advertisements shown in FIG. 3 (or any other suitable menu system). When an appropriate advertisement is to be selected, it can be highlighted or pointed to and selected using a select or enter key in the remote control 306. Upon doing so, the selections can be shown on the screen by highlighting. A highlighted selection is illustrated in menu selection representing advertisement 302, but the selection can, of course, be otherwise noted as having been selected. If the user fails to make appropriate selections, a default set of advertisements selected by the service provider 10 are used instead. However, those advertisements can be targeted using user profiles and other techniques.

In accordance with this embodiment, selected advertisements can be provided to the user in a number of ways. For example, the advertisements can be downloaded in parallel with the presentation of programming material by use of a cable modem within set-top box 22 and stored in disc drive 172 until time for presentation of any particular advertisement in any particular medium. Thus, a watermark or a banner advertisement or a 30-second conventional commercial could be stored in disc drive 172 (or in another disc drive attached to the set-top box as, for example, in the case of a personal video recorder) and played back at appropriate times either during a pause in the programming or by merging with the content in another manner.

By way of example, the information needed to present a banner advertisement or watermark can be downloaded to disc drive 172 and mixed with the incoming video for playback on the user's television 24. In the case of a commercial interruption, the video content being transmitted from the service provider 10 can be cached locally so that real time presentation of the video is not necessary. The content can include a marker whenever a certain type of advertisement is to be displayed. In other embodiments, rather than downloading the advertisements via the modem, the advertisements can be made available on unused channels in the video stream for merging with the active video of the entertainment content. Those skilled in the art will recognize many mechanisms for providing the advertising content and the entertainment content and merging these two elements together to create the final images displayed to the viewer.

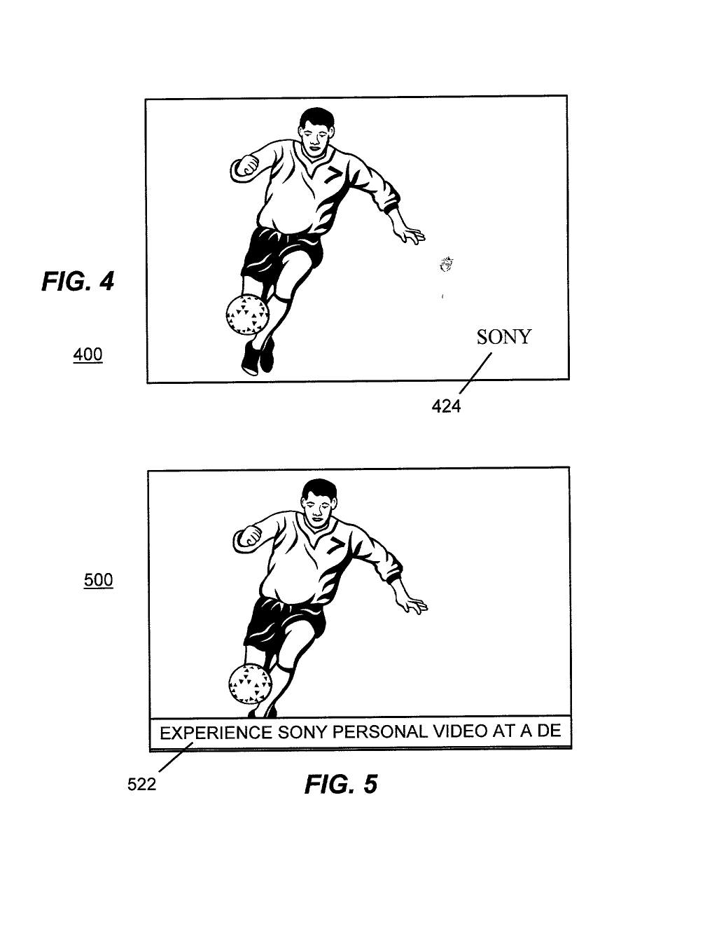

Referring now to FIG. 4, a screen image 400 displaying active video of programming content is illustrated in which a watermark 424 corresponding to selection 324 is illustrated. Although illustrated near the bottom right-hand corner of the display image, this should not be considered limiting. It is contemplated that the watermark may appear in other locations and, in fact, may move around the screen image or appear at various times in different locations to provide for a more effective presentation of the logo or other image used in the watermark.

Referring now to FIG. 5, a screen image 500 again with active entertainment content video playing simultaneously includes a banner style advertisement 522 corresponding to selection 322 from screen image 300.

Although the banner advertisement appears at the lower portion of screen 500, it could also appear within a window or a banner located anywhere on the screen.

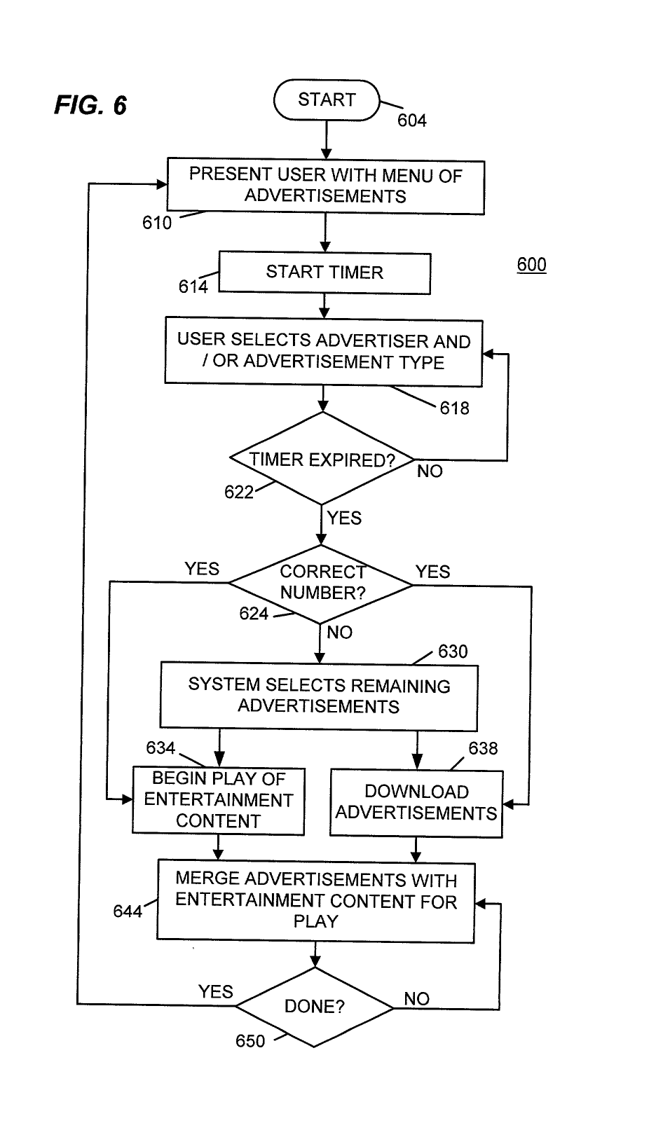

One method for implementing the process just described is shown in FIG. 6 as process 600. The process starts at 604 after which the user is presented with a menu of advertisements at 610 such as the menu shown in screen image 300. At 614, immediately upon presenting the user with the menu of advertisements, a timer is initiated. In the example shown in screen image 300, this timer might be a 30-second timer (and may be accompanied by an audible alert to the user), but this is not to be considered limiting since any appropriate time period can be used. At 618, during the time period when the timer is active, the user selects the advertisers and/or types of advertisements to be presented and is able to continue this process until 622 when the timer expires. Depending upon the embodiment, the user's selection of advertisements may be sent back to the service provider 10 or used at the set-top box 22 to carry out the process of the present invention. In one embodiment, the advertisements are merged with the entertainment content at the STB 22 for presentation to the user. In another embodiment, the advertisements are merged with the content at the service provider head end for presentation to the user (e.g., in a pay perview environment).

When the timer expires at 622, the system (for example, the CPU 132 of set-top box 22 operating under program control) determines if the user selected the correct number of advertisements (in the example shown, the correct number is 5). If not, the processor within the set-top box or a processor at the service provider 10 makes selections of additional advertisements to present to the user at 630 (e.g. randomly or according to any suitable criterion). Once its total number of advertisements corresponding to the number needed for presentation during the entertainment content is selected either at 624 or 630, the entertainment content begins playing at 634. Possibly simultaneously, the advertisements are downloaded at 638 from the service provider either via a channel that is designated for download of advertisements or via cable modem (DOCSIS or Out Of Band modem for example).

At 644, the advertisements are merged with the entertainment content for play to the user until the end of the entertainment content is reached at 650. Once the entertainment content is completed at 650, control returns to 610 for presentation of the next menu of advertisements in one embodiment. In other embodiments the present technique may only be used in certain entertainment content. In this case the process ends after 650. Numerous variations to this process (including parallel processing, reordering of the process and other variations) will occur to those skilled in the art upon consideration of this invention, without departing from the invention.

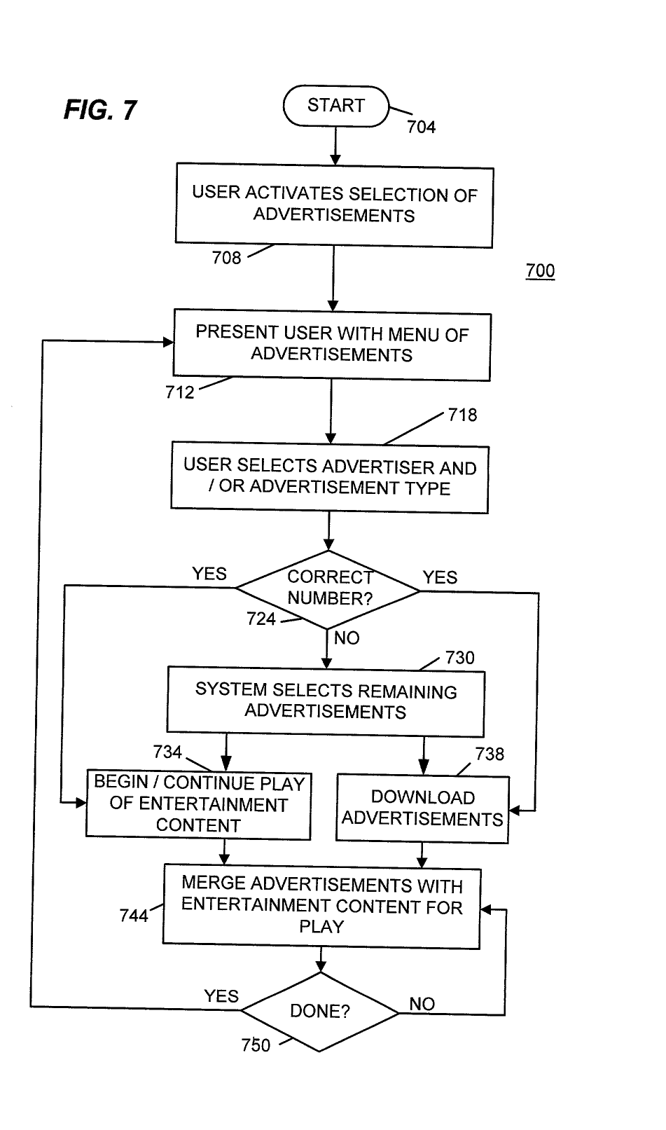

Referring now to FIG. 7, a method embodying an alternate embodiment of the present invention is illustrated as process 700 starting at 704. At 708 the user, for example using a dedicated button on remote control 36, activates a process to select advertisements. This causes the user to be presented with a menu of advertisements at 712, for example, for the current entertainment content being viewed. At 718, the user selects an advertiser and/or a type of advertisement that he or she wishes to view. Thus, the present embodiment operates to permit the user to modify the current presentation of advertising content or make new selections, for example, to see a previously viewed advertisement.

At 724, if the correct number of advertisements has not been selected, control passes to 730 where the remaining advertisements required are selected by the system as in the previous process. In either event, control passes from 724 or 730 to 734 where the entertainment content is started or continued and the appropriate advertisements are downloaded at 738 either on a dedicated channel for advertisements or downloaded via modem. At 744, the advertisements are merged with the entertainment content for display to the viewer until done at 750. At 750, when the content is completed, the user may be presented with an additional menu of advertisements at 712 or the process may simply terminate until the user again activates a selection on the remote control to enter stage 708. Again, many variations of this process are possible within the scope of the invention.

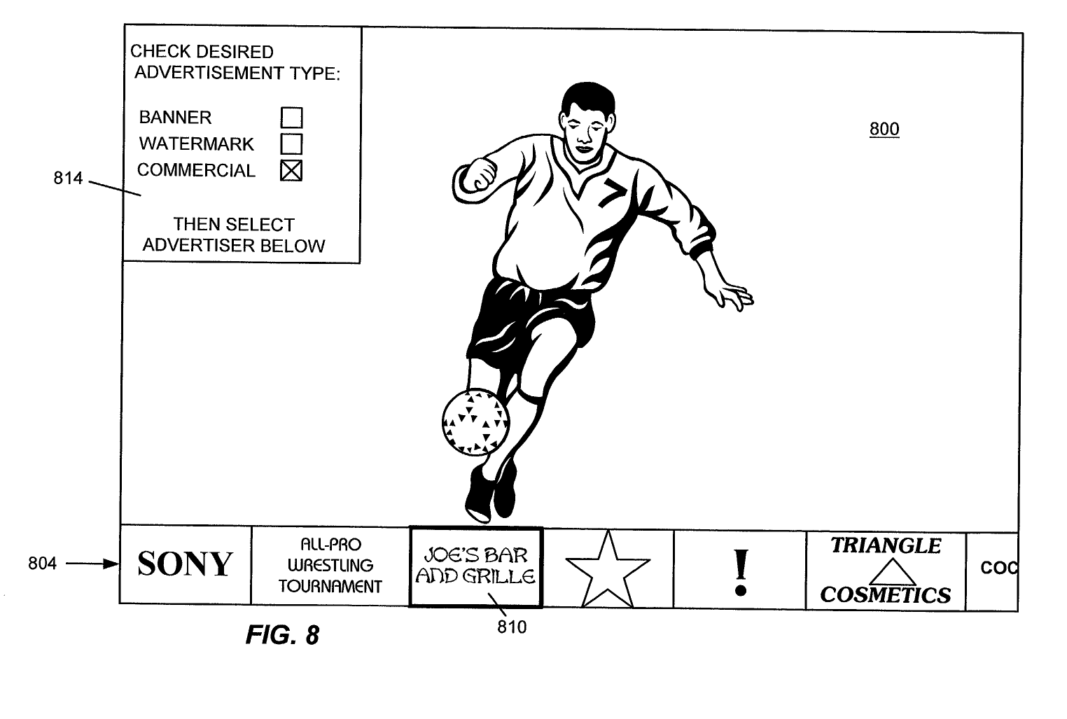

Referring now to FIG. 8, a screen image 800 illustrates another mechanism for selection of appropriate types of advertisement content. In this embodiment, the user is independently or dependently presented with a menu of types of advertisements as well as a menu of advertisements. In one embodiment of the implementation of the current embodiment, a scrolling menu of icons 804 is periodically presented to the user during the presentation of the entertainment content. The presentation appears to the user much like a “tickertape” of advertisement selections. The user can then make a selection from the scrolling menu for the next advertisement to be presented. In addition, the user can be presented with a menu of advertisement types from which to select for the next advertisement. Thus, for example, using navigation tools available through the remote control 36, the user might highlight the selection of advertisement 810 from the scrolling menu 804 while selecting a banner, watermark, or in this case, commercial advertisement from the window 814, depending on the level of intrusiveness of the advertisement the user is prepared to accept.

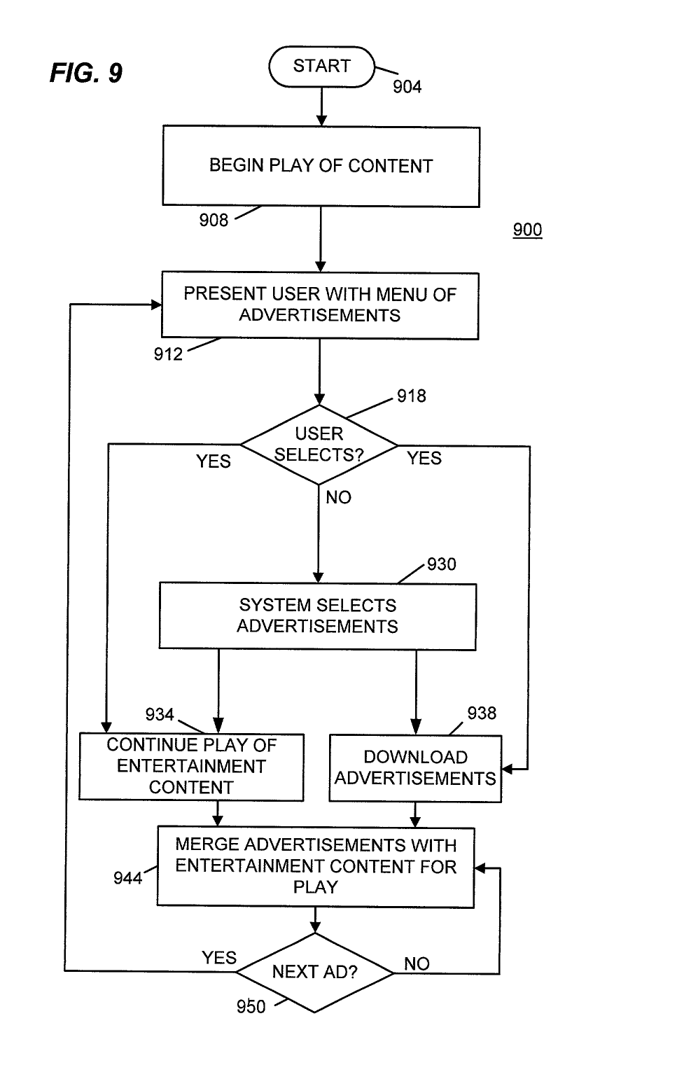

At this point, it is contemplated that the screen would clear except for the entertainment content. Upon reaching the next appropriate marker within the entertainment content, a commercial segment or other type of advertisement will be viewed for the advertiser identified in icon 810. The variation illustrated in FIG. 8 is described as process 900 depicted in FIG. 9. This process starts at 904 after which the system begins to play content at 908. Prior to a time for presentation of an advertisement, the user is presented with a menu of advertisements at 912. At 918 the user selects an advertisement during the presentation of the menu or else ignores the selection in which case the system selects an appropriate advertisement at 930 by any suitable selection mechanism (for example, rotation or targeted advertisement based on a user profile or content profile or time of day.)

In either event, control passes from 918 or 930 to 934 where the entertainment content continues while the appropriate advertisement is downloaded from the advertisement server 56 at the service provider 10 at 938. At 944 the advertisement is merged with the entertainment content for playback to the viewer until time for the next advertisement is reached at 950 at which point control returns to 912 where a new menu of advertisements is presented to the user. Many variations are possible without departing from the present invention. For example, although the download of advertisements has been depicted as occurring simultaneous with the play of entertainment content, the advertisements could be downloaded at high speed prior to the beginning of play. In another embodiment, the user's disc storage 172 (or other storage associated with the user's system) can be used as a cache for a substantial body of advertisements. Thus, in some situations, an advertisement may not need to be downloaded at all in order to merge the advertisements with the entertainment content. In other embodiments, advertisements can be embedded within the blanking interval of a conventional analog television signal and played back after selection in accordance with any suitable selection mechanism by the user. These and other variations will become evident to those skilled in the art upon consideration of the present invention.

It is contemplated that the ability to present advertisements in a variety of ways to the user will impact the business methods of the service providers and/or networks so that the charges (made from the service provider or network to the advertisers) associated with presentation of advertisements can be impacted by the type of advertisement presented. Moreover, with experience and testing, it can be determined how the effectiveness of various types of advertisements compare so that fee structures and times for the various advertisements can be factored into the business model. For example, as previously noted, a 30 second conventional advertisement might be as valuable as a 5 minute banner advertisement or a 20 minute watermark. Thus, charges for advertisements can be adjusted to provide availability to businesses having smaller amounts of funds to spend on advertisement. Consider for example, a pool of 5 local advertisers that might advertise for one minute each as a banner advertisement at substantially reduced prices. Many variations are possible without departing from the present invention.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

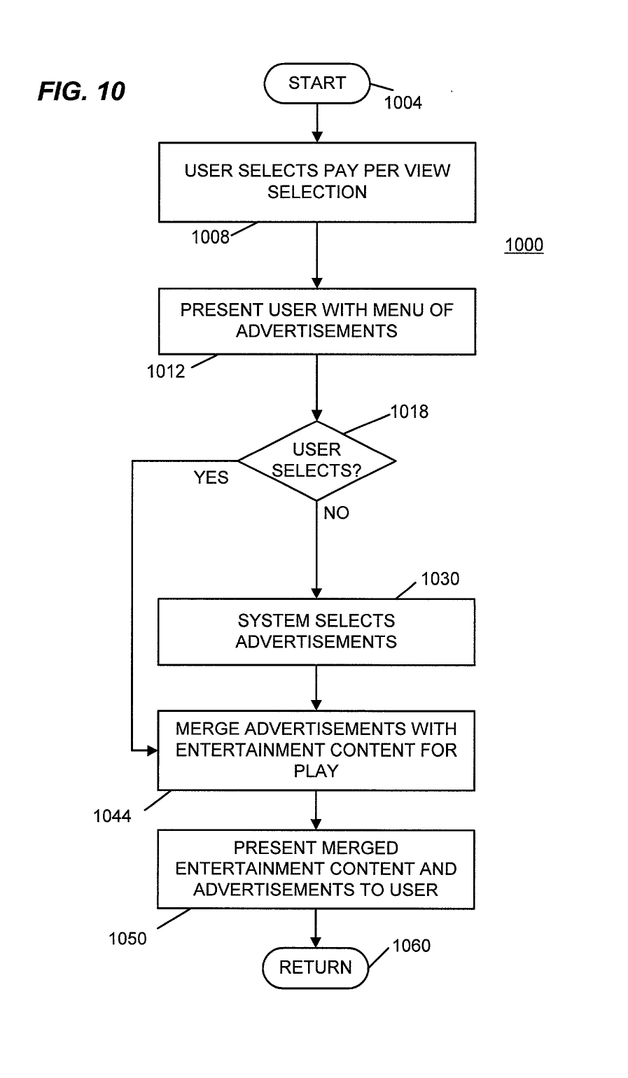

Referring now to FIG. 10, an alternative embodiment is illustrated as process 1000 starting at 1004 wherein a pay-per-view embodiment is illustrated in which the entertainment content and the advertisement is merged at the service provider. In this embodiment, the user selects a pay-per-view, video on demand or similar entertainment content selection at 1008. At 1012, the user is presented with a menu of possible advertisements as described previously. The user then selects advertisements from the menu at 1018, possibly within a given time limit as described previously. If the user fails to do so within prescribed limits, the system selects advertisements instead at 1030. In either case, the advertisements are then merged with the entertainment content at 1044 at the service provider (e.g., within media server 12) and the merged content is then presented to the user at 1050 from the service provider. The process then returns at 1060. Those skilled in the art will appreciate many variations in the present embodiment without departing from the invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form. However, those skilled in the art will appreciate that the processes described above can be implemented in any number of variations and in many suitable programming languages without departing from the present invention. For example, the order of certain operations carried out can often be varied, portions can be deleted or carried out in parallel, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of advertising, comprising:
presenting a menu possible advertisements to a user to permit the user to select an advertisement to view;
receiving a user selection of an advertisement to view; and
merging the advertisement with the stored entertainment content so that both the advertisement and the stored entertainment content are presented to the user.

2. The method according to claim 1, further comprising receiving the selected advertisement from an advertising server.

3. The method according to claim 1, further comprising presenting a menu of advertisement types to the user for selection.

4. The method according to claim 3, wherein the advertisement types include at least one of a conventional commercial segment, a banner advertisement and a watermark advertisement.

5. The method according to claim 1, wherein merging the advertisement with the stored entertainment content comprises inserting the advertisement at a location of an advertisement place holder forming a part of the entertainment content.

6. The method according to claim 1, wherein the selected advertisement is received via a modem.

7. The method according to claim 1, wherein the selected advertisement is received via a television channel.

8. The method according to claim 1, wherein the menu comprises a scrolling banner menu appearing simultaneously with entertainment content.

9. The method according to claim 1, wherein the menu is presented without simultaneous entertainment content.

10. The method according to claim 1, wherein the menu is presented within a window appearing simultaneously with entertainment content.

11. The method according to claim 3, wherein the menu comprises a scrolling banner menu appearing simultaneously with entertainment content.

12. The method according to claim 3, wherein the menu is presented without simultaneous entertainment content.

13. The method according to claim 3, wherein the menu is presented within a window simultaneously with entertainment content.

14. The method according to claim 3, wherein the advertisement and the advertisement type is presented to the user in a single menu.

15. The method according to claim 1, further comprising caching the selected advertisement in a storage device within a set-top box.

16. The method according to claim 1, further comprising caching the selected advertisement in a storage device coupled to a set-top box.

17. The method according to claim 1, wherein the presenting of the menu takes place as a result of receipt of a signal from the user requesting the presentation of the menu.

18. An electronic storage medium containing instructions which, when executed on a programmed processor carry out a process of advertising, comprising:
presenting a menu of possible advertisements to a user to permit the user to select an advertisement to view;
receiving a user selection of an advertisement to view;
receiving the selected advertisement from an advertising server; and
merging the advertisement with the stored entertainment content so that both the advertisement and the stored entertainment content are presented to the user.

19. The storage medium according to claim 18, further comprising presenting a menu of advertisement types to the user for selection.

20. The storage medium according to claim 19, wherein the advertisement types include at least one of a conventional commercial segment, a banner advertisement and a watermark advertisement.

21. The storage medium according to claim 18, wherein merging the advertisement with the stored entertainment content comprises inserting the advertisement at a location of an advertisement place holder forming a part of the entertainment content.

22. The storage medium according to claim 18, wherein the selected advertisement is received via a modem.

23. The storage medium according to claim 18, wherein the selected advertisement is received via a television channel.

24. The storage medium according to claim 18, wherein the menu comprises a scrolling banner menu appearing simultaneously with entertainment content.

25. The storage medium according to claim 18, wherein the menu is presented without simultaneous entertainment content.

26. The storage medium according to claim 18, wherein the menu is presented within a window appearing simultaneously with entertainment content.

27. The storage medium according to claim 19, wherein the menu comprises a scrolling banner menu appearing simultaneously with entertainment content.

28. The storage medium according to claim 19, wherein the menu is presented without simultaneous entertainment content.

29. The storage medium according to claim 19, wherein the menu is presented within a window simultaneously with entertainment content.

30. The storage medium according to claim 18, wherein the advertisement and the advertisement type is presented to the user in a single menu.

31. The storage medium according to claim 18, further comprising caching the selected advertisement in a storage device within a set-top box.

32. The storage medium according to claim 18, further comprising caching the selected advertisement in a storage device coupled to a set-top box.

33. A set-top box, comprising:
a programmed processor that presents a user with a menu of advertisements;
means for receiving a user selection of a selected advertisement from the menu of advertisements;
advertisement receiving means for receiving the selected advertisement from a service provider;
content receiving means for receiving entertainment content from the service provider; and
the programmed processor merging the entertainment content with the advertisement for presentation to the user.

34. The apparatus according to claim 33, further comprising a storage device forming a part of the set-top box to store the selected advertisement.

35. The apparatus according to claim 33, further comprising a storage device coupled to the set-top box to store the selected advertisement.

36. The apparatus according to claim 33, wherein the advertisement receiving means comprises a tuner.

37. The apparatus according to claim 33, wherein the advertisement receiving means comprises a modem.

38. The apparatus according to claim 33, wherein the means for receiving a user selection comprises an interface to a remote control device.

39. The apparatus according to claim 33, wherein the programmed processor further presents a menu of advertisement types to the user for selection.

40. The apparatus according to claim 39, wherein the advertisement types include at least one of a conventional commercial segment, a banner advertisement and a watermark advertisement.

41. The apparatus according to claim 39, wherein merging the advertisement with the stored entertainment content comprises inserting the advertisement at a location of an advertisement place holder forming a part of the entertainment content.

42. The apparatus according to claim 33, further comprising a modem and wherein the selected advertisement is received via the modem.

43. The apparatus according to claim 33, further comprising a tuner and wherein the selected advertisement is received via a television channel tuned by the tuner.

44. The apparatus according to claim 33, wherein the programmed processor presents a menu comprises a scrolling banner menu appearing simultaneously with entertainment content.

45. The apparatus according to claim 33, wherein the programmed processor presents the menu without simultaneous entertainment content.

46. The apparatus according to claim 33, wherein the programmed processor presents the menu within a window appearing simultaneously with entertainment content.

47. The apparatus according to claim 34, wherein the menu comprises a scrolling banner menu appearing simultaneously with entertainment content.

48. The apparatus according to claim 34, wherein the menu is presented without simultaneous entertainment content.

49. The apparatus according to claim 34, wherein the menu is presented within a window simultaneously with entertainment content.

50. The apparatus according to claim 34, wherein the advertisement and the advertisement type is presented to the user in a single menu.

51. The apparatus according to claim 33, wherein the means for receiving a user selection further comprises means for receiving a signal from the user requesting the presentation of the menu.

52. A method of advertising, comprising:
presenting a menu of possible types of advertisements to a user to permit the user to select a type of advertisement to view;
receiving a user selection of a type of advertisement to view;
receiving an advertisement of the selected advertisement type from an advertising server; and
merging the advertisement with the stored entertainment content so that both the advertisement and the stored entertainment content are presented to the user.

53. The method according to claim 52, further comprising presenting a menu of advertisements to the user for selection.

54. The method according to claim 52, wherein the advertisement types include at least one of a conventional commercial segment, a banner advertisement and a watermark advertisement.

55. The method according to claim 52, wherein merging the advertisement with the stored entertainment content comprises inserting the advertisement at a location of an advertisement place holder forming a part of the entertainment content.

56. The method according to claim 52, wherein the selected advertisement is received via a modem.

57. The method according to claim 52, wherein the selected advertisement is received via a television channel.

58. The method according to claim 52, wherein the menu comprises a scrolling banner menu appearing simultaneously with entertainment content.

59. The method according to claim 52, wherein the menu is presented without simultaneous entertainment content.

60. The method according to claim 52, wherein the menu is presented within a window appearing simultaneously with entertainment content.

61. The method according to claim 52, further comprising caching the selected advertisement in a storage device within a set-top box.

62. The method according to claim 52, further comprising caching the selected advertisement in a storage device coupled to a set-top box.

63. The method according to claim 52, wherein the advertisement is merged with the stored entertainment content at a service provider.

64. The method according to claim 52, wherein the advertisement is merged with the stored entertainment content at a service provider head end.

65. The method according to claim 52, wherein the advertisement is merged with the stored entertainment content at a set-top box.

66. An electronic storage medium containing instructions which, when carried out by a programmed processor, implements a method of advertising, comprising:
presenting a menu possible types of advertisements to a user to permit the user to select a type of advertisement to view;
receiving a user selection of a type of advertisement to view;
receiving an advertisement of the selected advertisement type from an advertising server; and
merging the advertisement with the stored entertainment content so that both the advertisement and the stored entertainment content are presented to the user.

67. The storage medium according to claim 66, further comprising presenting a menu of advertisements to the user for selection.

68. The storage medium according to claim 66, wherein the advertisement types include at least one of a conventional commercial segment, a banner advertisement and a watermark advertisement.

69. The storage medium according to claim 66, wherein merging the advertisement with the stored entertainment content comprises inserting the advertisement at a location of an advertisement place holder forming a part of the entertainment content.

70. The storage medium according to claim 66, wherein the selected advertisement is received via a modem.

71. The storage medium according to claim 66, wherein the selected advertisement is received via a television channel.

72. The storage medium according to claim 66, wherein the menu comprises a scrolling banner menu appearing simultaneously with entertainment content.

73. The storage medium according to claim 66, wherein the menu is presented without simultaneous entertainment content.

74. The storage medium according to claim 66, wherein the menu is presented within a window appearing simultaneously with entertainment content.

75. The storage medium according to claim 66, further comprising caching the selected advertisement in a storage device within a set-top box.

76. The storage medium according to claim 66, further comprising caching the selected advertisement in a storage device coupled to a set-top box.

77. The storage medium according to claim 66, wherein the advertisement is merged with the stored entertainment content at a service provider.

78. The storage medium according to claim 66, wherein the advertisement is merged with the stored entertainment content at a service provider head end.

79. The storage medium according to claim 66, wherein the advertisement is merged with the stored entertainment content at a set-top box.

80. A set-top box, comprising:
a programmed processor that presents a user with a menu of advertisement types;
means for receiving a user selection of a selected advertisement type from the menu of advertisements;
advertisement receiving means for receiving the selected advertisement from a service provider;
content receiving means for receiving entertainment content from the service provider; and
the programmed processor merging the entertainment content with the advertisement for presentation to the user.

81. The apparatus according to claim 80, further comprising a storage device forming a part of the set-top box to store the selected advertisement.

82. The apparatus according to claim 80, further comprising a storage device coupled to the set-top box to store the selected advertisement.

83. The apparatus according to claim 80, wherein the advertisement receiving means comprises a tuner.

84. The apparatus according to claim 80, wherein the advertisement receiving means comprises a modem.

85. The apparatus according to claim 80, wherein the means for receiving a user selection comprises an interface to a remote control device.

86. An advertising method, comprising:
presenting a television viewer with a menu of advertisements from which to select an advertisement for viewing;
receiving an advertisement selection from the television viewer; and
presenting the television viewer with the selected advertisement.

87. The method according to claim 88, further comprising:
presenting the television viewer with a menu of advertisement types;
receiving an advertisement type selection from the television viewer; and
presenting the television view with the selected advertisement according to the selected advertisement type.

88. The method according to claim 88, further comprising charging an advertiser for presenting the advertisement based upon a number of times the advertisement is selected by a group of television viewers.

89. The method according to claim 87, further comprising charging an advertiser for presenting the advertisement based upon a number of times the advertisement is selected by a group of television viewers and based upon the selected advertisement type presented.

90. An advertising method, comprising:
presenting the television viewer with a menu of advertisement types;
receiving an advertisement type selection from the television viewer; and
presenting the television viewer with the selected advertisement according to the selected advertisement type.

91. The method according to claim 90, further comprising charging an advertiser for presenting the advertisement based upon the selected advertisement type presented.

92. The method according to claim 90, wherein the advertisement type is selected from a first and a second advertisement type, with the first advertisement type being considered more intrusive to the viewer than the second advertisement type.

93. The method according to claim 92, wherein the presenting comprises presenting the first advertisement type for a first period of time if selected, and presenting the second advertisement type for a second period of time if selected, with the first period of time being less than the second period of time.
